(19) United States
(12) Patent Application Publication
(10) Pub. No.: US 2026/0228623 A1
(43) Pub. Date: Aug. 6, 2026

(54) NON-TRANSITORY COMPUTER-READABLE RECORDING MEDIUM AND INFORMATION PROCESSING DEVICE

(71) Applicant: Fujitsu Limited, Kawasaki-shi (JP)

(72) Inventor: Shunichi WATANABE, Kawasaki (JP)

(73) Assignee: Fujitsu Limited, Kawasaki-shi (JP)

(21) Appl. No.: 19/431,097

(22) Filed: Dec. 23, 2025

(30) Foreign Application Priority Data
Feb. 5, 2025 (JP) 2025-017743

(51) Int. Cl. G06N 20/00; G06T 7/194; G06T 11/60

(52) U.S. Cl. CPC G06N 20/00; G06T 7/194; G06T 11/60

(57) ABSTRACT

A non-transitory computer-readable recording medium has stored therein an inference program that causes a computer to execute a process including acquiring first image data captured in an environment that is different from an environment in pre-training of a machine learning model identifying a foreground area from the first image data generating composite image data based on the foreground area and second image data that is used in the pre-training of the machine learning model and acquiring an inference result by inputting the composite image data to the machine learning model.

### CROSS-REFERENCE TO RELATED APPLICATIONS

This application is based upon and claims the benefit of priority of the prior Japanese Patent Application No. 2025-017743, filed on February 5, 2025, the entire contents of which are incorporated herein by reference.

### FIELD

The embodiments discussed herein are related to a computer-readable recording medium and the like.

### BACKGROUND

As a measure to address labor shortages, there are many stores that are introducing self-checkout systems. While the self-checkout systems are convenient, problems may occur when customers forget to scan items or fail to scan and incorrectly register the items, which increases the demand for monitoring checkout fraud.

The related technologies are described, for example, in: Japanese Laid-open Patent Publication No. 2021-56803; Japanese Laid-open Patent Publication No. 2023- 47195; and Japanese Laid-open Patent Publication No. 2021-82155. For example, a conventional system for monitoring checkout fraud uses Human Object Interaction Detection (HOID). The task of HOID is to detect interactions between a person and an object from an image.

FIG. 12 is a diagram for describing the task of HOID. In the example illustrated in FIG. 12, an area A1-1 of a person and an area A1-2 of an object (something) are identified from an image Im1, and an interaction "hold" between the person and the object is detected.

The task of HOID is realized by a machine learning model and the like. For example, by setting up a pre-trained machine learning model on a server of a store and inputting an image captured by a camera of the store into the machine learning model, an interaction between a person and an object can be detected.

Note here that there may be accuracy degradation in the inference results of the machine learning model, since there are differences between the background information of the training data used in the pre-training and the background information of the actual store. For this reason, in the related technologies, the pre-trained machine learning model is fine-tuned in accordance with the environment of the store.

FIG. 13 is a diagram for describing a related technology. In the related technology, for example, the processing of steps S10 to S12 is performed in sequence as described below.

In the related technology, a machine learning model 50 is trained using a training dataset 10 that is prepared in advance (step S10). In the related technology, image data of a store is collected in advance to prepare an additional training dataset 11 (step S11). For example, at step S11, several hundred units of image data are captured to prepare the training dataset 11.

In the related technology, the machine learning model 50 is fine-tuned using the additional training dataset 11 (step S12). In the related technology, the fine-tuned machine learning model 50 is used to execute the tasks of HOID on the images captured by the camera of the store.

However, there is room for improvement in the related technologies described above.

For example, the related technologies are not capable of efficiently solving the problems regarding accuracy degradation when detecting interactions between persons and objects, since there are additional man-hours for collecting store image data in advance and for fine tuning.

### SUMMARY

According to an aspect of an embodiment, a non-transitory computer-readable recording medium has stored therein an inference program that causes a computer to execute a process including acquiring first image data captured in an environment that is different from an environment in pre-training of a machine learning model identifying a foreground area from the first image data generating composite image data based on the foreground area and second image data that is used in the pre-training of the machine learning model and acquiring an inference result by inputting the composite image data to the machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a system according to a first embodiment;

FIG. 2 is a diagram for describing processing of an information processing device according to the first embodiment;

FIG. 3 is a functional block diagram illustrating the configuration of the information processing device according to the first embodiment;

FIG. 4 is a flowchart illustrating the processing procedure of the information processing device according to the first embodiment;

FIG. 5 is a diagram illustrating a system according to a second embodiment;

FIG. 6 is a diagram (1) for describing processing of an information processing device according to the second embodiment;

FIG. 7 is a diagram (2) for describing processing of the information processing device according to the second embodiment;

FIG. 8 is a functional block diagram illustrating the configuration of the information processing device according to the second embodiment;

FIG. 9 is a flowchart (1) illustrating the processing procedure of the information processing device according to the second embodiment;

FIG. 10 is a flowchart (2) illustrating the processing procedure of the information processing device according to the second embodiment;

FIG. 11 is a diagram illustrating an example of the hardware configuration of a computer that realizes the same functions as the information processing device of the embodiments;

FIG. 12 is a diagram for describing a task of HOID; and

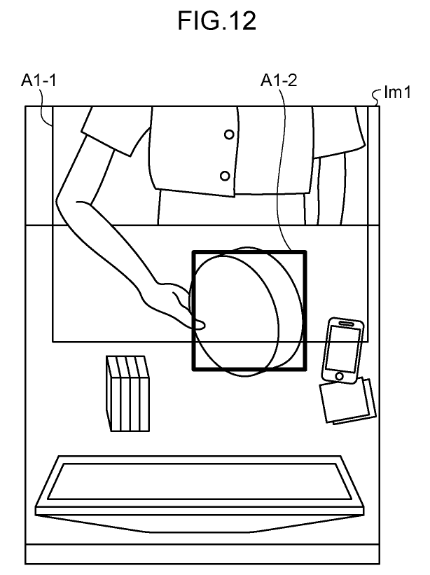

FIG. 13 is a diagram for describing a related technology.

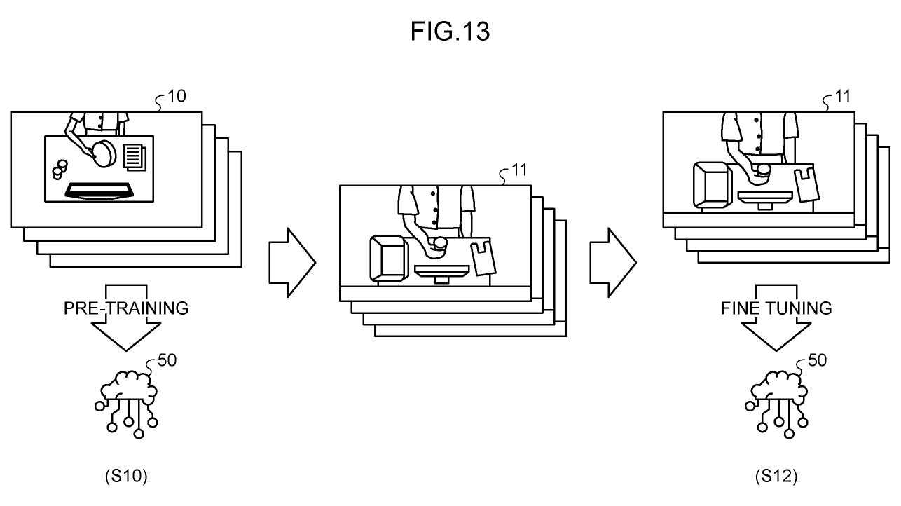

### DESCRIPTION OF EMBODIMENTS

Preferred embodiments of the present invention will be explained with reference to accompanying drawings. Note that the present invention is not limited by the embodiments.

### First Embodiment

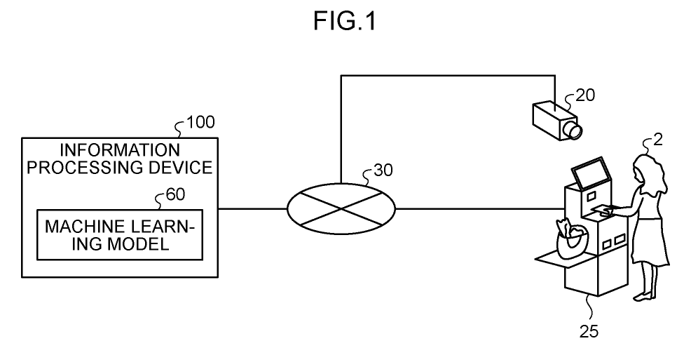

FIG. 1 is a diagram illustrating a system according to a first embodiment. As illustrated in FIG. 1, the system includes a camera 20, a self-checkout 25, and an information processing device 100. The camera 20, the self-checkout 25, and the information processing device 100 are interconnected via a network 30. For example, the camera 20 and the self-checkout 25 are installed in a store.

The camera 20 is a camera that captures videos including the self-checkout 25. The camera 20 transmits data of the captured video to the information processing device 100. In the following description, the data of the video transmitted from the camera 20 to the information processing device 100 is referred to as "video data."

Video data contains a plurality of image frames in a time series. A frame number is assigned to each image frame in ascending chronological order. One image frame is a still image captured by the camera 20 at a certain timing. Time data may also be added to each image frame.

The self-checkout 25 is a POS checkout system in which a user 2 who is purchasing an item performs everything from reading the bar code of the item to making payment. For example, when the user 2 moves an item to be purchased to the scan area of the self-checkout 25, the self-checkout 25 scans the barcode of the item.

The user 2 repeatedly executes the above operation and, when the scanning of items is completed, operates the touch panel or the like of the self-checkout 25 to make a request for settlement. Upon accepting the request for settlement, the self-checkout 25 presents the number of items to be purchased, the purchase amount, and the like to execute the settlement processing. The self-checkout 25 stores, in a storage unit, information of the items scanned between the time at which the user 2 starts scanning and the time at which the user makes a request for settlement and transmits the information to the information processing device 100 as item data.

The information processing device 100 detects interactions between a person and objects from video data (image frames) using a pre-trained machine learning model 60. Based on the detected result, the information processing device 100 verifies the item data acquired from the self-checkout 25.

Here, the processing of the information processing device 100 for detecting interactions between a person and objects from the video data using the pre-trained machine learning model 60 will be described in a more specific manner. The information processing device 100 does not perform fine tuning unlike the related technologies.

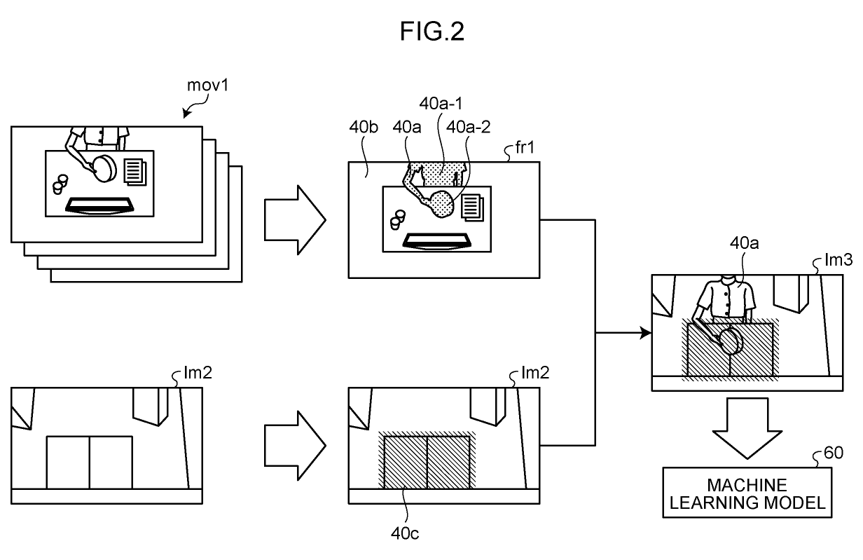

FIG. 2 is a diagram for describing the processing of the information processing device according to the first embodiment. As illustrated in FIG. 2, the information processing device 100 acquires video data mov1 captured in real time from the camera 20. For example, the information processing device 100 classifies an image frame fr1 contained in the video data mov1 into a foreground area 40a and a background area 40b. The foreground area 40a is an area that includes an area 40a-1 of a person and an area 40a-2 of an object the person is grasping. The background area 40b is the area of the image frame fr1 from which the foreground area 40a is excluded.

In the meantime, the information processing device 100 holds background data Im2 that is used in the pre-training. For example, it is assumed that in the pre-training, the machine learning model 60 is trained using a training dataset that includes a person and an object in the background data Im2. The information processing device 100 identifies a checkout area 40c included in the background data Im2. The checkout area 40c in the background data Im2 may also be designated in advance.

The information processing device 100 cuts out the foreground area 40a of the image frame fr1 and generates composite image data Im3 by taking into account the positional relationship between the foreground area 40a and the checkout area 40c of the background data Im2. For example, the composite image data Im3 corresponds to image data in which the background area 40b of the image frame fr1 is replaced by the background data Im2. The information processing device 100 generates the composite image data Im3 such that the coordinates of the center of gravity of the foreground area 40a coincides with the coordinates of the center point of the checkout area 40c.

The information processing device 100 inputs the composite image data Im3 to the machine learning model 60 to infer the interaction between the person and the object.

As described above, the information processing device 100 according to the first embodiment acquires the video data mov1 (image frame fr1) captured in an environment that is different from the environment at the time of the pre-training, generates the composite image data Im3 by combining the foreground area 40a of the image frame fr1 and the background data Im2, and inputs the composite image data Im3 into the machine learning model 60 to detect (infer) the interaction between the person and the object.

Since the background area excluding the foreground area in the composite image data Im3 is the same background as the background in the pre-training, the accuracy degradation when detecting an interaction between a person and an object can be efficiently eliminated even if the environment in which the machine learning model 60 is operated is different from the environment in the pre-training. In addition, an interaction between a person and an object can be inferred with high accuracy without executing fine tuning of the machine learning model 60.

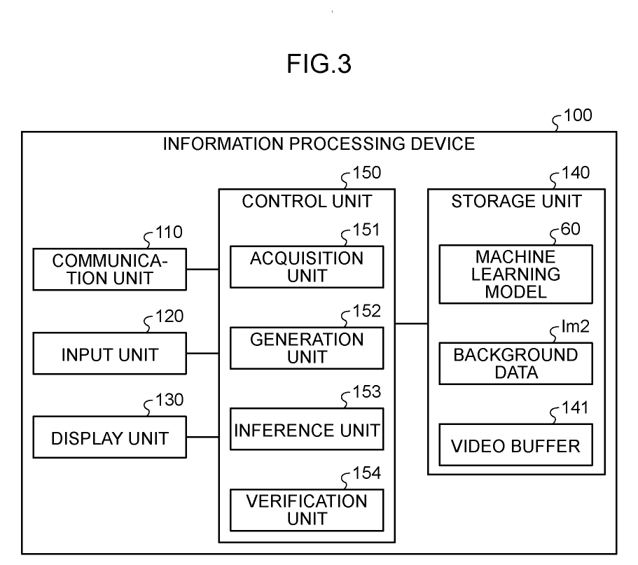

Next, a configuration example of the information processing device 100 according to the first embodiment will be described. FIG. 3 is a functional block diagram illustrating the configuration of the information processing device according to the first embodiment. As illustrated in FIG. 3, the information processing device 100 includes a communication unit 110, an input unit 120, a display unit 130, a storage unit 140, and a control unit 150.

The communication unit 110 executes data communication between the camera 20, the self-checkout 25, and external devices via the network 30. For example, the communication unit 110 receives video data from the camera 20. The communication unit 110 receives item data from the self-checkout 25. The communication unit 110 may receive the background data Im2 and the data of the pre-trained machine learning model 60 from an external device.

The input unit 120 is an input device that inputs various kinds of information to the control unit 150 of the information processing device 100. The user may operate the input unit 120 to input the background data Im2.

The display unit 130 is a display device that displays information output from the control unit 150.

The storage unit 140 has the machine learning model 60, the background data Im2, and a video buffer 141. The storage unit 140 is a memory or the like.

The machine learning model 60 is a pre-trained machine learning model that executes the tasks of HOID. For example, the machine learning model 60 is a Neural Network (NN), You Only Look Once (YOLO), InteractNet, Visual Semantic Graph Network (VSGNet), or the like. By inputting image data into the machine learning model 60, the area of the person and the area of the object associated with the person included in the image data are identified, and the interaction between the person and the object is inferred.

The background data Im2 is background data that is used in the pre-training of the machine learning model 60. In the pre-training, it is assumed that the machine learning model 60 is trained using a training dataset that includes a person and an object included in the background data Im2. Other description regarding the background data Im2 is the same as the description for the background data Im2 indicated in FIG. 2.

The video buffer 141 is a buffer that holds the video data acquired from the camera 20.

The control unit 150 includes an acquisition unit 151, a generation unit 152, an inference unit 153, and a verification unit 154. The control unit 150 is a Central Processing Unit (CPU), a Graphics Processing Unit (GPU), or the like.

The acquisition unit 151 acquires the video data from the camera 20. The acquisition unit 151 stores the acquired video data in the video buffer 141.

The generation unit 152 acquires the image frame fr1 from the video buffer 141 and generates the composite image data Im3 based on the image frame fr1 and the background data Im2. The processing of the generation unit 152 corresponds to the processing described in FIG. 2.

For example, the generation unit 152 identifies the foreground area 40a from the image frame fr1 using a segmentation technology. The generation unit 152 identifies the checkout area 40c of the background data Im2. The checkout area 40c of the background data Im2 may be designated in advance by the user.

The generation unit 152 cuts out the foreground area 40a of the image frame fr1 and generates the composite image data Im3 by taking into account the positional relationship between the foreground area 40a and the checkout area 40c of the background data Im2. For example, the generation unit 152 generates the composite image data Im3 such that the coordinates of the center of gravity of the foreground area 40a coincides with the coordinates of the center point of the checkout area 40c. The generation unit 152 may adjust the Euclidean distance between the coordinates of the center of gravity of the foreground area 40a and the coordinates of the center point of the checkout area 40c to be less than a threshold. The threshold is set in advance. The generation unit 152 outputs the generated composite image data Im3 to the inference unit 153.

The inference unit 153 infers an interaction between a person and an object by inputting the composite image data Im3 to the machine learning model 60. The inference unit 153 outputs the inference result to the verification unit 154. The inference result includes the area of the person and the area of the object associated with the person included in the image frame fr1 as well as the interaction between the person and the object.

The generation unit 152 and the inference unit 153 execute the above-described processing for each frame of the video data stored in the video buffer 141.

The verification unit 154 executes various kinds of verification processing based on a series of inference results acquired from the inference unit 153 and item data acquired from the self-checkout 25. For example, the verification unit 154 infers the number of items to be purchased from the movement trajectory and the like of the objects grasped by the person indicated in the inference result, determines whether the inferred number of purchased items matches the number of items that are scanned to be purchased by the user 2 before making a request for settlement, and outputs the determination result to the display unit 130 for display.

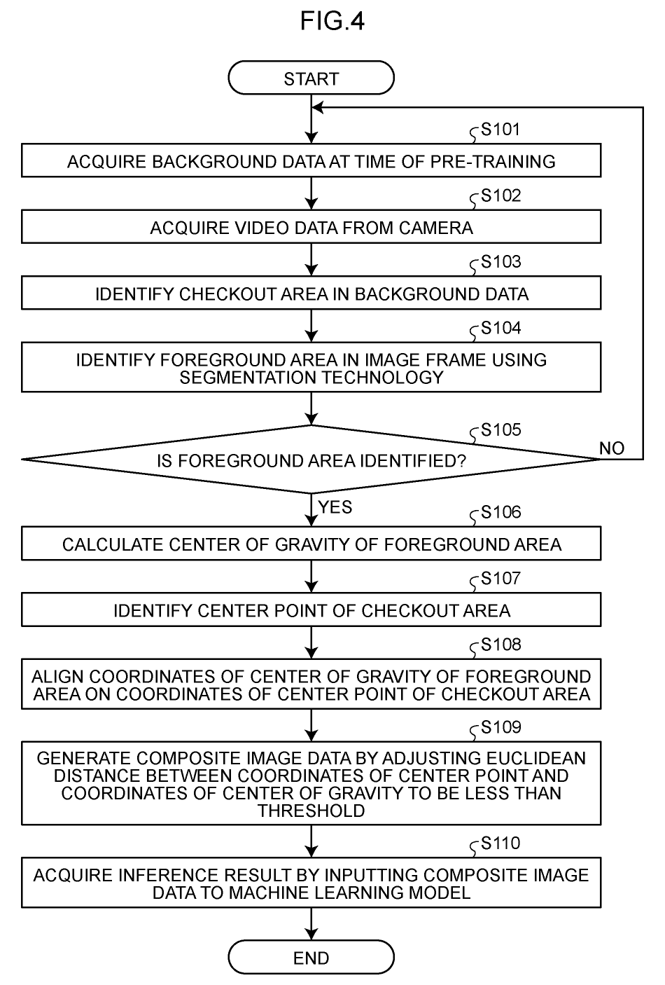

Next, an example of the processing procedure of the information processing device 100 according to the first embodiment will be described. FIG. 4 is a flowchart illustrating the processing procedure of the information processing device according to the first embodiment. As illustrated in FIG. 4, the acquisition unit 151 of the information processing device 100 acquires the background data Im2 used at the time of pre-training (step S101). The acquisition unit 151 acquires video data (image frames) from the camera 20 (step S102).

The generation unit 152 of the information processing device 100 identifies the checkout area in the background data Im2 (step S103). The generation unit 152 identifies the foreground area in the image frame using a segmentation technology (step S104).

When unable to identify the foreground area (No at step S105), the generation unit 152 shifts to step S101. In the meantime, when the foreground area is identified (Yes at step S105), the generation unit 152 calculates the center of gravity of the foreground area (step S106).

The generation unit 152 identifies the center point of the checkout area (step S107). The generation unit 152 aligns the coordinates of the center of gravity of the foreground area on the coordinates of the center point of the checkout area in the background data Im2 (step S108). The generation unit 152 generates the composite image data Im3 by adjusting the Euclidean distance between the coordinates of the center point and the coordinates of the center of gravity to be less than a threshold (step S109).

The inference unit 153 of the information processing device 100 inputs the composite image data Im3 into the machine learning model to acquire the inference result (step S110).

Next, the effects of the information processing device 100 according to the first embodiment will be described. The information processing device 100 according to the first embodiment acquires the video data mov1 (image frame fr1) captured in an environment that is different from the environment at the time of the pre-training, generates the composite image data Im3 by combining the foreground area 40a of the image frame fr1 and the background data Im2, and inputs the composite image data Im3 into the machine learning model 60 to detect (infer) the interaction between the person and the object.

Thereby, the accuracy degradation when detecting an interaction between a person and an object can be efficiently eliminated even if the environment in which the machine learning model 60 is operated is different from the environment at the time of the pre-training. In addition, an interaction between a person and an object can be inferred with high accuracy without executing fine tuning of the machine learning model 60. In other words, it is possible to efficiently eliminate the problem of accuracy degradation when detecting the interaction between a person and an object in an environment that is different from the environment at the time of the pre-training.

### Second Embodiment

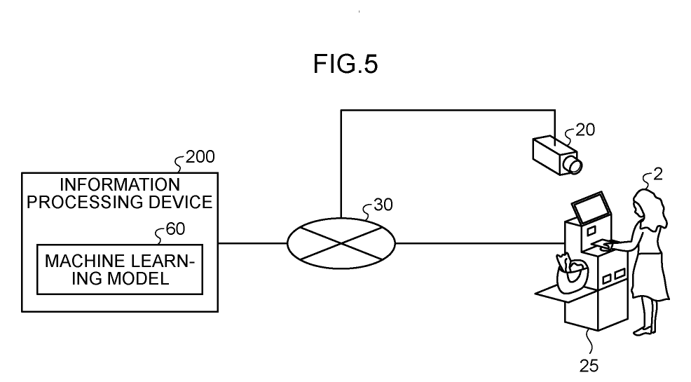

Subsequently, a system according to a second embodiment will be described. FIG. 5 is a diagram illustrating the system according to the second embodiment. As illustrated in FIG. 5, the system includes a camera 20, a self-checkout 25, and an information processing device 200. The camera 20, the self-checkout 25, and the information processing device 200 are interconnected via a network 30. For example, the camera 20 and the self-checkout 25 are installed in a store.

The descriptions regarding the camera 20 and the self-checkout 25 are the same as those of the camera 20 and the self-checkout 25 described in FIG. 1.

The information processing device 200 detects interactions between a person and objects from video data (image frames) after executing fine tuning on a pre-trained machine learning model 60. Based on the detected result, the information processing device 200 verifies the item data acquired from the self-checkout 25.

As will be described below, when executing fine tuning, the information processing device 200 uses only a single piece of image data captured using the camera 20. Therefore, although fine tuning is executed, it is possible with the information processing device 200 to reduce the man-hours for collecting image data of the store in advance compared to the cases of the related technologies.

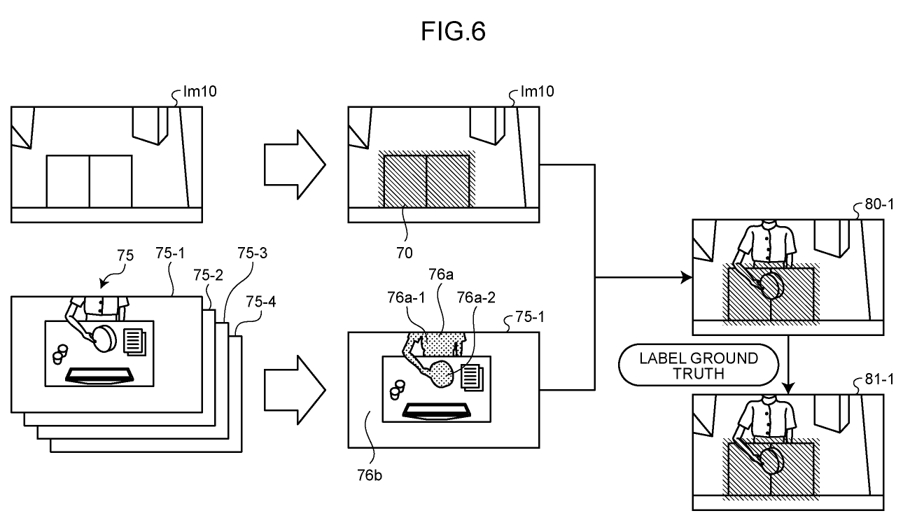

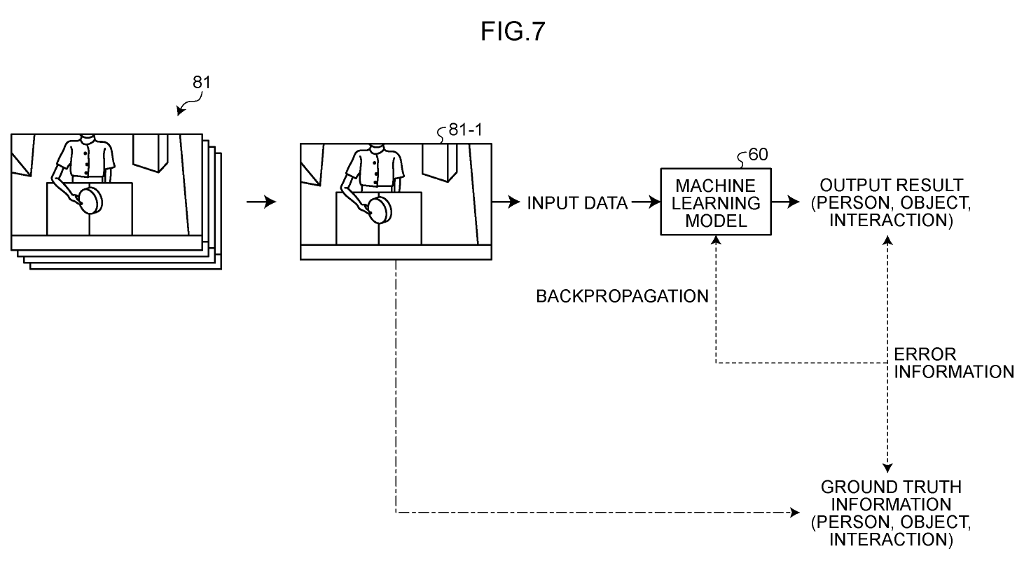

FIG. 6 and FIG. 7 are diagrams for describing the fine tuning executed by the information processing device according to the second embodiment. First, FIG. 6 will be described. The information processing device 200 acquires a single piece of image data Im10 captured by the camera 20. The information processing device 200 identifies a checkout area 70 included in the image data Im10. Note that the checkout area 70 in the image data Im10 may be designated in advance.

In the meantime, the information processing device 200 acquires a training dataset 75 used at the time of pre-training. The training dataset 75 contains a plurality of pieces of training data. The training data includes image data corresponding to the input data and ground truth information. In the ground truth information, the area of the person (bounding box) and the area of the object (bounding box) included in the image data as well as the interaction are set. In the following description, the image data and the ground truth information are collectively referred to as training data. While the example in FIG. 6 illustrates training data 75-1, 75-2, 75-3, and 75-4, the training dataset 75 includes other training data as well.

For example, the information processing device 200 acquires the training data 75-1 and classifies the training data 75-1 into a foreground area 76a and a background area 76b. The foreground area 76a is an area that includes an area 76a-1 of a person and an area 76a-2 of an object the person is grasping.

The information processing device 200 cuts out the foreground area 76a of the training data 75-1 and generates composite image data 80-1 by taking into account the positional relationship between the foreground area 76a and the checkout area 70 of the image data Im10. The information processing device 200 also generates training data 81-1 for fine tuning by setting the ground truth information of the training data 75-1 to the composite image data 80-1.

The information processing device 200 executes the same processing as that of the above-described training data 75-1 also for the training data 75-2 to 75-4 and other training data, not illustrated, included in the training dataset 75 to generate training data for fine tuning.

Next, FIG. 7 will be described. The information processing device 200 executes fine tuning on the machine learning model 60 using the training dataset 81 for fine tuning created in the processing illustrated in FIG. 6. The initial values of the parameters of the machine learning model 60 are the values of the parameters acquired as a result of the pre-training.

The information processing device 200 acquires the training data 81-1 (input data and ground truth information) from the training dataset 81 and inputs the input data to the machine learning model 60 to acquire an output result from the machine learning model 60. The output result includes the area (class) of a person, the area (class) of an object, an interaction between the person and the object detected by the machine learning model 60. Then, the information processing device 200 calculates error information between the ground truth information of the training data 81-1 and the output result of the machine learning model 60 and updates the parameters of the machine learning model 60 by backpropagation such that the error becomes smaller. The information processing device 200 acquires other training data from the training dataset 81 and repeats the above- described processing to execute machine learning (fine tuning) of the machine learning model 60.

The information processing device 200 uses the fine-tuned machine learning model 60 to detect interactions between the person and the objects from the video data (time-series image frames) acquired from the camera 20.

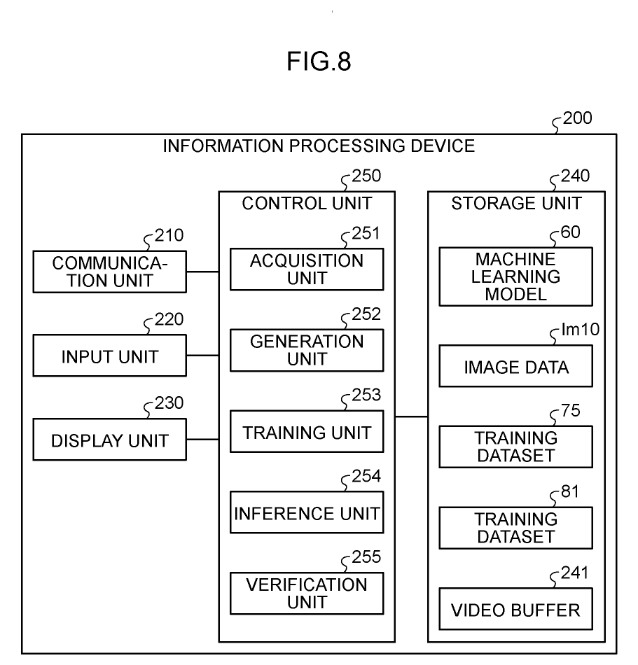

Next, a configuration example of the information processing device 200 according to the second embodiment will be described. FIG. 8 is a functional block diagram illustrating the configuration of the information processing device according to the second embodiment. As illustrated in FIG. 8, the information processing device 200 includes a communication unit 210, an input unit 220, a display unit 230, a storage unit 240, and a control unit 250.

The communication unit 210 executes data communication between the camera 20, the self-checkout 25, and external devices via the network 30. For example, the communication unit 210 receives video data from the camera 20. The communication unit 210 receives item data from the self-checkout 25. The communication unit 210 may receive the image data Im10, the pre-trained machine learning model 60, and the data of the training dataset 75 from an external device.

The input unit 220 is an input device that inputs various kinds of information to the control unit 250 of the information processing device 200. The user may operate the input unit 220 to input the image data Im10 and the like.

The display unit 230 is a display device that displays information output from the control unit 250.

The storage unit 240 has the machine learning model 60, the image data Im10, the training datasets 75, 81, and a video buffer 241. The storage unit 240 is a memory or the like.

The machine learning model 60 is a pre-trained machine learning model that executes the tasks of HOID. For example, the machine learning model 60 is NN, YOLO, InteractNet, VSGNet, or the like. By inputting image data into the machine learning model 60, the area of the person and the area of the object associated with the person included in the image data are identified, and the interaction between the person and the object is inferred.

The image data Im10 is the image data captured by the camera 20 to execute fine tuning.

The training dataset 75 is the training dataset that is used when pre-training the machine learning model 60. Other description regarding the training dataset 75 is the same as the description regarding the training dataset 75 described in FIG. 6.

The training dataset 81 is the training dataset generated to execute fine tuning. For example, the training dataset 81 is generated by the processing described in FIG. 6.

The video buffer 241 is a buffer that holds the video data acquired from the camera 20.

The control unit 250 includes an acquisition unit 251, a generation unit 252, a training unit 253, an inference unit 254, and a verification unit 255. The control unit 250 is a CPU, a GPU, or the like.

When executing fine tuning, the acquisition unit 251 acquires the machine learning model 60, the image data Im10, and the training dataset 75, and stores those in the storage unit 240.

After the fine tuning of the machine learning model 60 is completed, the acquisition unit 251 acquires video data from the camera 20 and stores it in the video buffer 241.

The generation unit 252 generates the training dataset 81 for fine tuning based on the image data Im10 and the training dataset 75 that is used at the time of the pre-training. The processing of the generation unit 252 corresponds to the processing described in FIG. 6.

For example, the generation unit 252 acquires the training data 75-1 from the training dataset 75 and identifies the foreground area 76a of the training data 75-1 using the segmentation technology. The generation unit 252 identifies the checkout area 70 of the image data Im10. The generation unit 252 cuts out the foreground area 76a of the training data 75-1 and generates the composite image data 80-1 by taking into account the positional relationship between the foreground area 76a and the checkout area 70 of the image data Im10.

For example, the generation unit 252 generates the composite image data 80-1 such that the coordinates of the center of gravity of the foreground area 76a coincides with the coordinates of the center point of the checkout area 70. The generation unit 252 may adjust the Euclidean distance between the coordinates of the center of gravity of the foreground area 76a and the coordinates of the center point of the checkout area 70 to be less than a threshold. The threshold is set in advance.

The generation unit 252 also generates the training data 81-1 for fine tuning by setting the ground truth information of the training data 75-1 to the composite image data 80-1. The generation unit 252 executes the same processing as that of the above-described training data 75-1 also for the training data 75-2 to 75-4 (and other training data, not illustrated) included in the training dataset 75 to generate the training dataset 81 for fine tuning.

The training unit 253 executes fine tuning of the machine learning model 60 using the training dataset 81. The description of the fine tuning executed by the training unit 253 is the same as the description in FIG. 7.

The inference unit 254 acquires an image frame from the video buffer 241 and inputs the acquired image frame to the fine-tuned machine learning model 60 to infer the interaction between the person and the object. The inference unit 254 outputs the inference result to the verification unit 255. The inference result includes the area of the person and the area of the object associated with the person included in the image frame as well as the interaction between the person and the object.

The inference unit 254 executes the above-described processing for each frame of the video data stored in the video buffer 241.

The verification unit 255 executes various kinds of verification processing based on a series of inference results acquired from the inference unit 254 and item data acquired from the self-checkout 25. For example, the verification unit 255 infers the number of items to be purchased from the movement trajectory and the like of the objects grasped by the person indicated in the inference result, determines whether the inferred number of purchased items matches the number of items that are scanned to be purchased by the user 2 before making a request for settlement, and outputs the determination result to the display unit 130 for display.

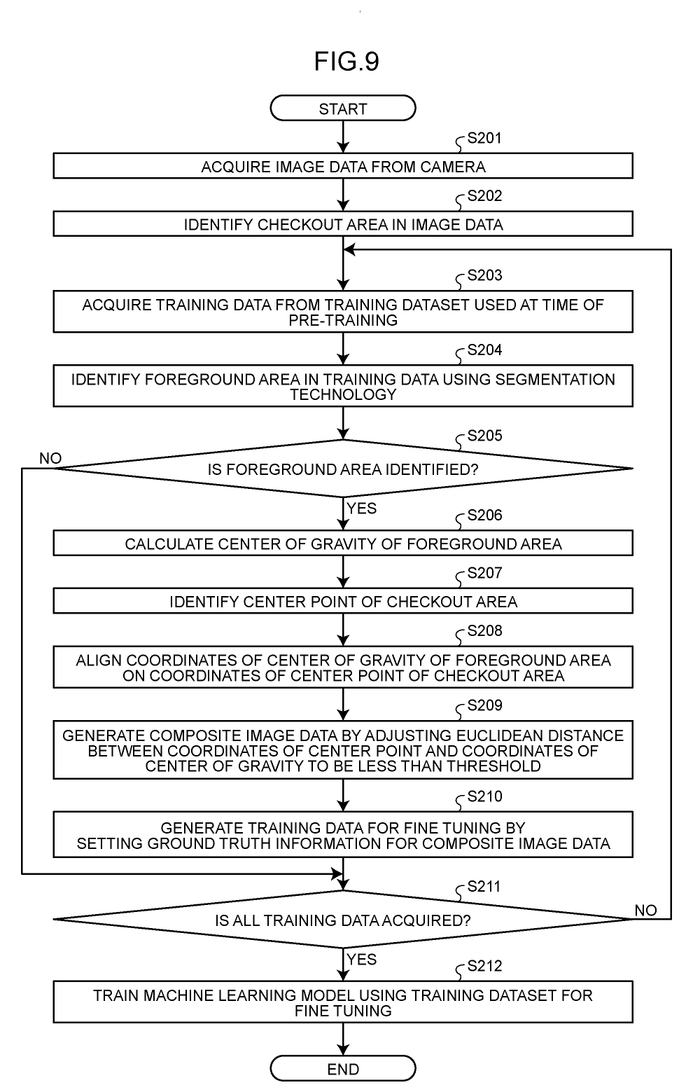

Next, an example of the processing procedure of the information processing device 200 according to the second embodiment will be described. FIG. 9 is a flowchart (1) illustrating the processing procedure of the information processing device according to the second embodiment. As illustrated in FIG. 9, the acquisition unit 251 of the information processing device 200 acquires the image data Im10 from the camera 20 (step S201). The generation unit 252 of the information processing device 200 identifies the checkout area in the image data Im10 (step S202).

The generation unit 252 acquires the training data from the training dataset 75 used at the time of the pre-training (step S203). The generation unit 252 identifies the foreground area in the training data using a segmentation technology (step S204). When unable to identify the foreground area (No at step S205), the generation unit 252 shifts to step S211.

In the meantime, when the foreground area is identified (Yes at step S205), the generation unit 252 calculates the center of gravity of the foreground area (step S206). The generation unit 252 identifies the center point of the checkout area (step S207). The generation unit 252 aligns the coordinates of the center of gravity of the foreground area on the coordinates of the center point of the checkout area in the image data Im10 (step S208). The generation unit 252 generates the composite image data by adjusting the Euclidean distance between the coordinates of the center point and the coordinates of the center of gravity to be less than a threshold (step S209).

The generation unit 252 also generates the training data for fine tuning by setting the ground truth information for the composite image data (step S210). When not all the training data is acquired from the training dataset 75 used at the time of the pre-training (No at step S211), the generation unit 252 shifts to step S203.

In the meantime, when all the training data is acquired (Yes at step S211), the information processing device 200 shifts to step S212. The training unit 253 of the information processing device 200 trains the machine learning model 60 using the training dataset 81 for fine tuning (step S212).

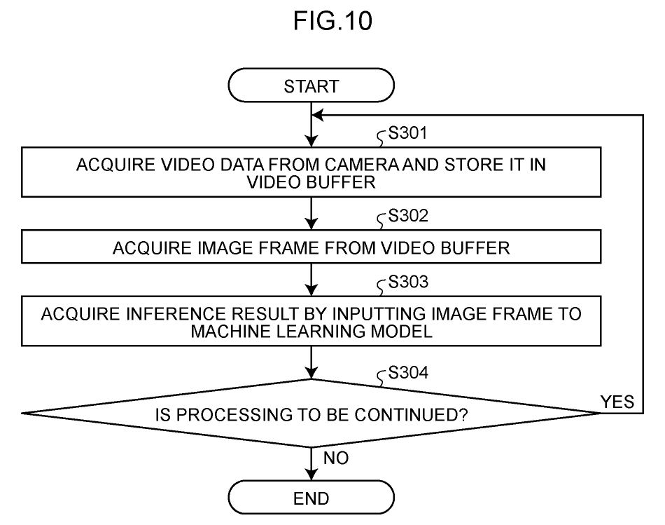

FIG. 10 is a flowchart (2) illustrating the processing procedure of the information processing device according to the second embodiment. The processing illustrated in FIG. 10 is performed after the processing illustrated in FIG. 9 is executed. As illustrated in FIG. 10, the acquisition unit 251 of the information processing device 200 acquires the video data from the camera 20 and stores it to the video buffer (step S301).

The inference unit 254 of the information processing device 200 acquires the image frame from the video buffer 241 (step S302). The inference unit 254 inputs the image frame to the machine learning model and acquires the inference result (step S303).

When continuing the processing (Yes at step S304), the information processing device 200 shifts to step S301. When not continuing the processing (No at step S304), the information processing device 200 ends the processing. Note that the verification unit 255 of the information processing device 200 may execute various verifications based on the inference results.

Next, the effects of the information processing device 200 according to the second embodiment will be described. The information processing device 200 generates the training dataset 81 for fine tuning based on the training dataset 75 used at the time of the pre-training and a single piece of image data Im10 captured in an environment that is different from the environment in the pre-training. For example, the information processing device 200 identifies the checkout area of the image data Im10 and the foreground area of the training data acquired from the training dataset 75 and generates composite image data by taking into account the positions of the checkout area and the foreground area. The information processing device 200 generates the training data for fine tuning by setting the ground truth information for the composite image data. The information processing device 200 performs additional training on the machine learning model 60 using the training dataset 81 for fine tuning.

As described above, although fine tuning of the machine learning model 60 is executed, it is possible with the information processing device 200 to reduce the man-hours for collecting image data of the store in advance and to improve the accuracy of the inference results of the machine learning model 60 compared to the cases of the related technologies.

Next, an example of the hardware configuration of a computer that realizes the same functions as the information processing device 100 (200) presented in the above embodiments will be described in order.

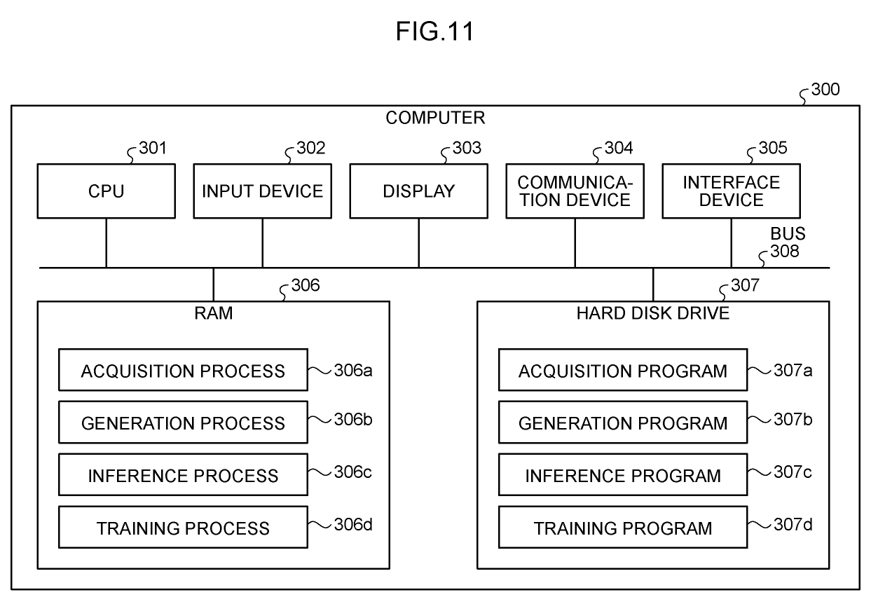

FIG. 11 is a diagram illustrating an example of the hardware configuration of a computer that realizes the same functions as the information processing device of the embodiments. As illustrated in FIG. 11, a computer 300 includes a CPU 301 that executes various kinds of arithmetic processing, an input device 302 that receives input of data from the user, and a display 303. The computer 300 also includes: a communication device 304 that transmits and receives data to and from the camera 20, the self-checkout 25, and the like via a wired or wireless network; and an interface device 305. In addition, the computer 300 includes a RAM 306 for temporary storing various kinds of information, and a hard disk drive 307. Each of the devices 301 to 307 is connected to a bus 308.

The hard disk drive 307 has an acquisition program 307a, a generation program 307b, an inference program 307c, and a training program 307d. The CPU 301 reads out each of the programs 307a to 307d and loads it into the RAM 306.

The acquisition program 307a functions as an acquisition process 306a. The generation program 307b functions as a generation process 306b. The inference program 307c functions as an inference process 306c. The training program 307d functions as a training process 306d.

The processing of the acquisition process 306a corresponds to the processing of the acquisition units 151 and 251. The processing of the generation process 306b corresponds to the processing of the generation units 152 and 252. The processing of the inference process 306c corresponds to the processing of the inference units 153 and 254. The processing of the training process 306d corresponds to the processing of the training unit 253.

Note that each of the programs 307a to 307d does not always need to be stored in the hard disk drive 307 from the beginning. For example, each of the programs is stored on a "removable physical medium" such as a flexible disk (FD), a CD-ROM, a DVD, a magneto-optical disk, an IC card, or the like that is inserted into the computer 300. Then, the computer 300 may read out and execute each of the programs 307a to 307d.

It is possible to efficiently eliminate the problem of accuracy degradation when detecting the interaction between a person and an object in an environment that is different from the environment at the time of the pre-training.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A non-transitory computer-readable recording medium having stored therein an inference program that causes a computer to execute a process comprising:
acquiring first image data captured in an environment that is different from an environment in pre-training of a machine learning model;
identifying a foreground area from the first image data;
generating composite image data based on the foreground area and second image data that is used in the pre-training of the machine learning model; and
acquiring an inference result by inputting the composite image data to the machine learning model.

2. The non-transitory computer-readable recording medium according to claim 1, wherein the process further includes identifying a target from the second image data and generating the composite image data based on a position of the foreground area and a position of the target.

3. The non-transitory computer-readable recording medium according to claim 2, wherein the process further includes generating the composite image data such that a distance between coordinates of a center of gravity of the foreground area and coordinates of a center point of the target becomes less than a threshold.

4. A non-transitory computer-readable recording medium having stored therein a training program that causes a computer to execute a process comprising:
identifying a foreground area from first image data in training data that is used in pre-training of a machine learning model;
generating composite image data based on the foreground area and second image data captured in an environment that is different from an environment in the pre-training of the machine learning model; and
executing fine tuning of the machine learning model based on the composite image data.

5. The non-transitory computer-readable recording medium according to claim 4, wherein the process further includes generating new training data for executing the fine tuning by associating the composite image data with ground truth information of the training data and
executing the fine tuning on the machine learning model based on the new training data.

6. An information processing device comprising:
a memory; and
a processor coupled to the memory and configured to:
acquire first image data captured in an environment that is different from an environment in pre-training of a machine learning model;
identify a foreground area from the first image data;
generate composite image data based on the foreground area and second image data that is used in the pre-training of the machine learning model; and
acquire an inference result by inputting the composite image data to the machine learning model.

7. The information processing device according to claim 6, wherein the processor is further configured to
identify a target from the second image data, and
generate the composite image data based on a position of the foreground area and a position of the target.

8. The information processing device according to claim 7, wherein the processor is further configured to generate the composite image data such that a distance between coordinates of a center of gravity of the foreground area and coordinates of a center point of the target becomes less than a threshold.

9. An information processing device comprising:
a memory; and
a processor coupled to the memory and configured to:
identify a foreground area from first image data in training data that is used in pre-training of a machine learning model;
generate composite image data based on the foreground area and second image data captured in an environment that is different from an environment in the pre-training of the machine learning model; and
execute fine tuning of the machine learning model based on the composite image data.

10. The information processing device according to claim 9, wherein the processor is further configured to
generate new training data for executing the fine tuning by associating the composite image data with ground truth information of the training data, and
execute the fine tuning on the machine learning model based on the new training data.
